(19) United States
(12) Patent Application Publication
(10) Pub. No.: US 2013/0136259 A1
(43) Pub. Date: May 30, 2013

(54) Scanner, Terminal and Method For Reading an Optical Code with Authenticatable Information

(71) Applicant: JOHN CROOK, DULUTH, GA (US)

(72) Inventor: JOHN CROOK, DULUTH, GA (US)

(73) Assignee: NCR CORPORATION, DULUTH, GA (US)

(21) Appl. No.: 13/308,150

(22) Filed: Nov. 30, 2011

(51) Int. Cl. H04N 1/44

(52) U.S. Cl. 380/243

(57) ABSTRACT

A scanner, terminal and method are provided for reading an optical code where a portion of the information stored in the optical code is encrypted. In accordance with an aspect of the invention, a public cryptographic key associated with the optical code is used to decrypt the encrypted portion of the information and data from the decrypted portion is used to authenticate the remainder of the information.

### RELATED APPLICATION

The present application is related to U.S. patent application Ser. No. 13/308,128, concurrently filed with this application and entitled “AN APPARATUS, METHOD AND SYSTEM FOR GENERATING AN OPTICAL CODE WITH AUTHENTICATABLE INFORMATION.” The present application and the related application are commonly assigned.

### FIELD OF THE INVENTION

The present invention relates generally to optical codes. More particularly, but not exclusively, the invention relates to preventing the fraudulent use of information stored in an optical code by encrypted certain data stored in optical codes.

### BACKGROUND

Any discussion of prior art throughout the specification should in no way be considered as an admission that such prior art is widely known or forms part of common general knowledge in the field.

Point of sale (POS) terminals are used throughout the retail industry to process purchase transactions. A POS terminal typically includes a personal computer (PC) core in a chassis, one or more displays, an optical code scanner with weigh scale, a cash drawer, a magnetic stripe reader (MSR), keyboard and a printer. The POS terminals can either be self-service or assisted service.

The optical code scanner includes an imaging scanner and may also include a laser scanner. The two scanners use different technologies to independently read optical codes such as barcodes presented to the scanner. The laser scanner reads a barcode by sweeping a beam of laser light across a barcode, capturing data representing the reflected laser light, and then processing the captured data to recover information encoded in the barcode. An imaging scanner reads a barcode by capturing a complete image of the barcode and then processing the image to recover information encoded in the barcode.

Optical codes, such as barcodes or QR codes, are generally affixed to or printed on items being presented to a POS terminal for purchase. The optical codes include information about the item they are affixed to or printed on. This information can include identification information for the item and the weight of the item if it is prepackaged and sold by weight. Some retailers have experienced a type of fraud where a person presents a false optical code, sometimes on a cell phone, instead of scanning the actual item being presented to the POS terminal for purchase. The false optical code has weight information that either matches or is approximately equal to the actual item so a weigh scale included in the POS terminal does not detect the substitution.

Therefore, to prevent the above fraud, as well as other related frauds, there is a need to determine if an optical code being presented to a POS terminal for scanning actually corresponds to the item being presented for purchase.

### SUMMARY OF THE INVENTION

It is an object of the present invention to overcome or ameliorate at least one of the disadvantages of the prior art, or to provide a useful alternative.

Among its several aspects, one embodiment of the present invention recognizes the need to prevent the use of a false optical code to identify an item. A false optical code is an optical code used to identify an item when it is not associated with or intended to be used to identify the item. A false optical code can be presented in printed form or displayed on an electronic device such as a cell phone. A false optical code includes inaccurate or false information and when used to identify an item causes the item to be misidentified or mispriced or both. One aspect of the present invention reads an optical code where a portion of the information stored in the optical code is encrypted. The type of cryptography used decrypts and authenticates the encrypted data and thus prevents unauthorized parties from generating encrypted data to create a false optical code. In addition, certain information included in the encrypted data is used to identify the item associated with the optical code.

In still another embodiment, two optical codes are used to identify a single item. One or both of the optical codes includes encrypted data but the data from both of the optical codes are required before the encrypted data can be decrypted and authenticated.

In accordance with an embodiment of the present invention, there is provided an optical code scanner for reading an optical code where a portion of the information stored in the optical code is encrypted. The optical code scanner comprising: An optical code scanner including: an image capture device where the image capture device captures an image of an optical code presented to the optical code scanner for reading; a computer memory adapted to store computer data and computer executable instructions; and a processor in communication with the image capture device, and the computer memory. Where the processor executes the instructions and where the instructions cause the processor to perform steps including: receiving the captured image of the optical code from the image capture device; processing the received image to recover data stored in the optical code where a portion of the recovered data is encrypted; identifying a cryptographic key associated with the recovered data from optical code; decrypting using the cryptographic key the encrypted portion of the recovered data to produce a clear text version of the encrypted portion; and authenticating the recovered data using information from the clear text version of the encrypted data and rejecting the optical code if the authentication fails and accepting the optical code data if the authentication passes.

A more complete understanding of the present invention, as well as further features and advantages of the invention, will be apparent from the following Detailed Description and the accompanying Drawings.

### BRIEF DESCRIPTION OF THE DRAWINGS

The aspects of the claimed invention can be better understood with reference to the Drawings and the Detailed Description. The Drawings are not necessarily drawn to scale. Throughout the Drawings, like element numbers are used to describe the same parts throughout the various drawing, figures and charts.

FIG. 1 is a high-level drawing in block form illustrating an exemplar embodiment of a scaling and labeling system.

FIG. 2 is a high-level block diagram illustrating an exemplar embodiment of a point-of-sale system.

FIG. 3 is a high-level block diagram illustrating an exemplar embodiment of an imaging scanner.

FIG. 4 is a high-level flow chart illustrating an exemplar method for generating a label for a variable weight item including an optical code with encrypted data.

FIG. 5 is a high-level flow chart illustrating an exemplar method for reading a label for a variable weight item including an optical code with encrypted data.

### DETAILED DESCRIPTION

In the following description, numerous details are set forth to provide an understanding of the claimed invention. However, it will be understood by those skilled in the art that the claimed invention may be practiced without these details and that numerous variations or modifications from the described embodiments are possible.

The term optical code, as used herein, includes both one and two dimensional barcodes. In addition, two dimensional barcodes include Quick Response (QR) codes and Data Matrix codes. The term optical code is not intended to be limited to just these examples but include machine readable codes that provide unique information or identification.

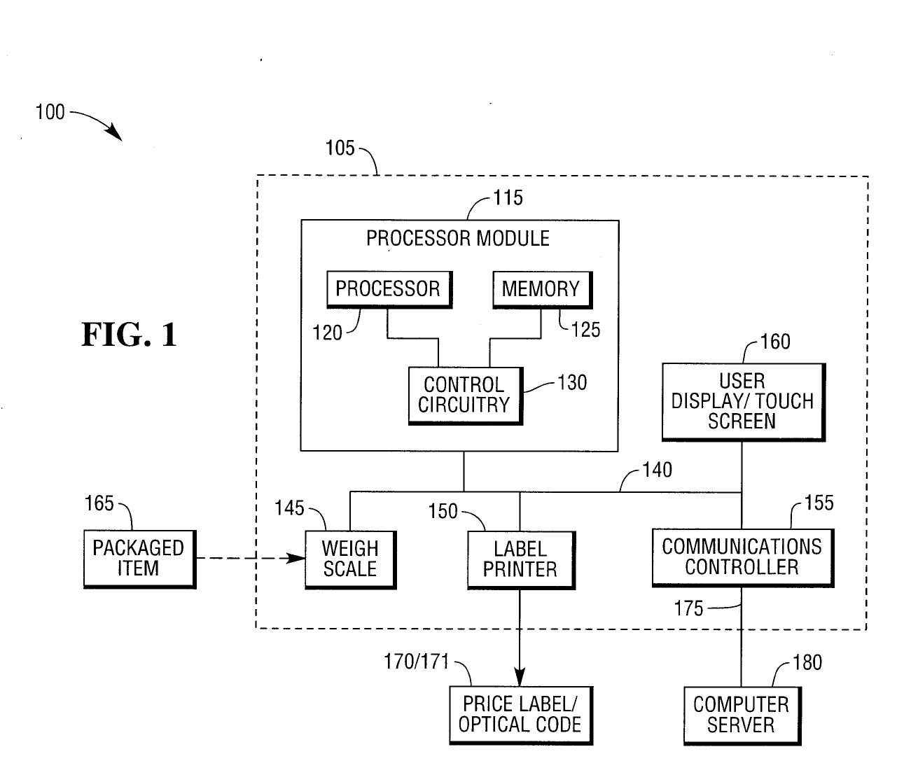

Turning to FIG. 1, there is provided a high-level drawing in block form illustrating an exemplar embodiment of a scaling and labeling system 100. The system includes a computer server 180 connected to a scaling and labeling device 105 over a computer network 175. The computer server 180 receives and sends data to the scaling and labeling device 105. The scaling and labeling device 105 include a processor module 115, a weigh scale 145, a label printer 150, communications controller 155 and a user display/touch screen 160.

Within the processor module 115, there is included a processor 120, a memory 125 and control circuitry 130. The memory 125 includes both volatile and non-volatile memory. Software stored in the memory 125 is executed by the processor 120 and causes the processor 125 to control the devices and operation of the scaling and labeling device 105. The control circuitry 130 provides an interface between the processor 120 and the memory 125 and between the processor 120 a data bus 140 used to communicate with other devices that comprise the scaling and labeling device 105 including but limited to the weigh scale 145, the label printer 150, the communications controller 155 and the user display and touch screen 160. In some embodiments, all or a portion of the memory 125 is connected directly to the processor 120.

The scaling and labeling device 105 is used to determine the weight of a packaged item 165 where the item 165 is sold by weight. The weight of these items varies so the actual weight must be determined before the total price of each item can be calculated. Examples of such items include packaged meat, packaged cheeses and packaged deli products. The item 165 is placed on the weigh scale 145 and the weight of the item 165 is determined. The processor 120 receives the weight of the item 165 from the weigh scale 145 and then calculates a total price for the item 165 using the item's weight and a unit weight price for the item 165. The processor 120 then generates a unique price label 170 for the item 165 and prints the label 170 using the label printer 150. The unit weight price is entered on the touch screen 160 or retrieved from the computer server 180. The processor 120 displays information including item weight and total price on the user display 160.

Included on the price label 170 is human readable information such as the unit price, total price, total weight and item identification information. The price label 170 further includes an optical code 171 that is generated by the processor 120. The optical code 171 includes item identification information, price and weight information. In some embodiments, the optical code 171 also includes additional information such as an expiration date.

A portion of the information stored in optical code 171 is encrypted by the processor 120. The information is encrypted using a public-key cryptography system. A public-key cryptography system uses matched public and private keys to encrypt/decrypt data and authenticate the party that encrypted the data. In a public-key cryptography system, a party uses a private key of a key pair to encrypt data and publishes a matched public key of the key pair that is used to decrypt the encrypted data. The public key is the only key that will decrypt the data and the public key cannot be used to encrypt false data that is substituted for the encrypted data. The private key is kept secret but the public key is general available to anybody that has a legitimate need for it. Because only the public key can decrypt data encrypted by the matching private key, being able to successfully decrypt the data proves that the data was encrypted by the private key and generally used to authenticate the source of the data.

In some embodiments, the process of encrypting the data includes performing a hashing function on some or all of the information stored in the optical code. A hashing function is cryptographic function that processes data to generate a unique signature, sometimes referred to as a hash. Generally, the hashing function is performed on information that will not be encrypted and/or information prior to being encrypted. Examples of hashing functions include MD5, SHA-3 and BLAKE. In the embodiment, the hashing function produces a first unique signature that is included as part of the encrypted data stored in the optical code. When the optical code is read, the encrypted data is also read and then decrypted using the matching public key. The hashing function is then performed on some or all of the decrypted data along with the data that was not encrypted to create a second unique signature. If the first and second unique signatures are identical, the encrypted data has been properly decrypted and the data has not been altered since the original hashing function was performed.

The portion of the information stored in the optical code that is never encrypted or decrypted is referred to as clear text. The portion of the information stored in the optical code that is encrypted is referred to as plain text before it is encrypted and after it is decrypted and as encrypted data when it is encrypted.

In some embodiments, a party identifier is stored in the optical code 171. The party identifier is stored in clear text (never encrypted) and is associated with a party that generated the encrypted data. The party may be a company that packages, weighs and labels items or a company that contracts to have the work performed. In one example, the company is a store where items are packaged, weighed, labeled and placed on display for purchase. Items are then selected and presented to a POS terminal to be scanned for purchase. In another example, the company is a suppler to a store where the item is shipped to the store and placed on display for purchase. The item is then selected and presented to a POS terminal to be scanned for purchase. The party identifier is associated with a public key and is used by the POS terminal to retrieve or identify the public key that is then used to decrypt the encrypted data stored in the optical code 171.

In some embodiments, the process of encrypting the data does not involve using a public-key cryptography system but instead uses a simpler cipher that modifies/encrypts the original data using a first function where a second function can be used to recreate the original data. An XOR cipher is a one example of a function that encrypts and decrypts data but does not use a public key. An XOR cipher encrypts data by applying a bitwise XOR operation to every byte using a given key. The data is decrypted by reapplying the bitwise XOR operation to every byte using the same given key. In these embodiments, the size of the data prior to encryption is the same as after encryption. In addition, embodiments that use this type of cipher generally use one dimensional optical codes and the labeling of an item and the purchase of the item usually occur in the same store. The store can create the given key and make sure it is used to create the labeling for an item and also used by the POS terminals to decrypt the data. Because one dimensional optical codes (barcodes) are used, a laser scanner is able to read them.

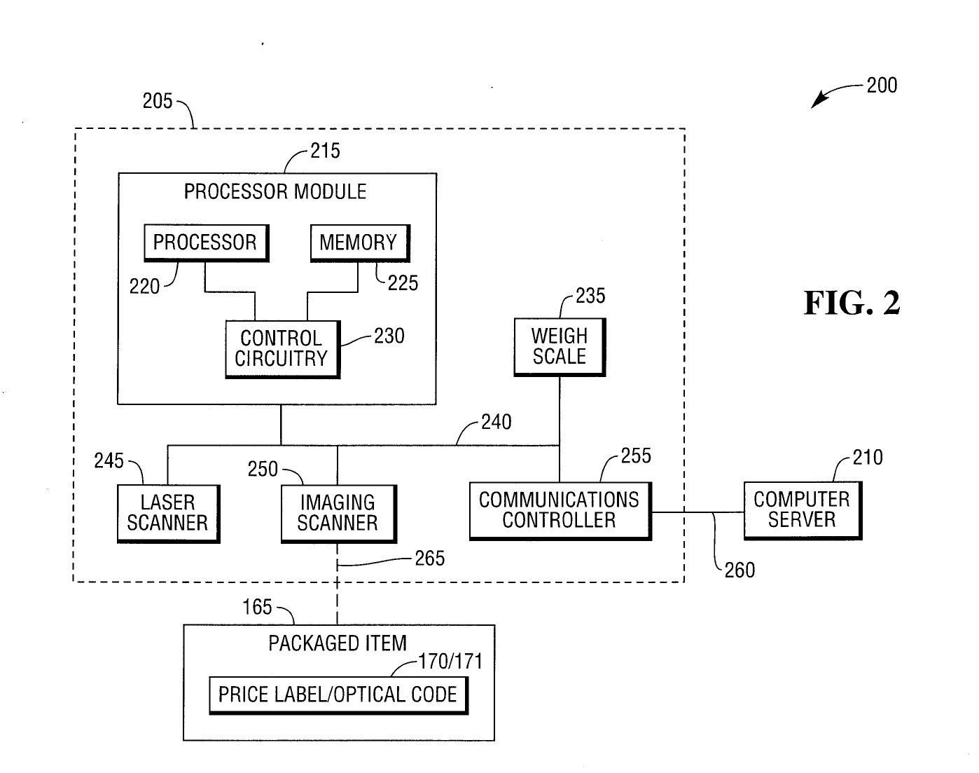

Referring now to FIG. 2, there is provided a high-level block diagram illustrating an exemplar embodiment of a point of sale (POS) system 200. The POS system 200 can be either an assisted or self-checkout system. The POS system 200 includes a POS terminal 205 connected over a data network 260 to a computer server 210. The POS terminal 205 includes a processor module 215, a laser scanner 245, an imaging scanner 250, a weigh scale 235 and a communications controller 255. In some embodiments, the POS terminal 205 does not include a laser scanner 245.

The processor module 215, includes a processor 220, a memory 225 and control circuitry 230. The memory 225 includes both volatile and non-volatile memory. Software stored in the memory 225 is executed by the processor 220 and causes the processor 220 to control the devices and operation of the POS terminal 205. The control circuitry 230 provides an interface between the processor 220 and the memory 225 and between the processor 220 a data bus 240 used to communicate with other devices that comprise the POS terminal 205 including but not limited to the laser scanner 245, the imaging scanner 250 and the communications controller 255. In some embodiments, all or a portion of the memory 225 is connected directly to the processor 220.

The imaging scanner 250 has a viewing path 265. The imaging scanner 250 can generally capture and read optical codes located in the viewing path 265. The optical code 171 printed on the price label 170 of the packaged item 165 is located in the viewing path 265 of the imaging scanner 250.

The weigh scale 235 is used to weigh items being presented for purchase to the POS terminal 200. The scale 235 can also be used as a security scale to determine if an item identified for purchase has the correct predetermined weight value.

The communications controller 255 includes hardware and software required to communicate with external devices such as the computer server 210 over the data network 260.

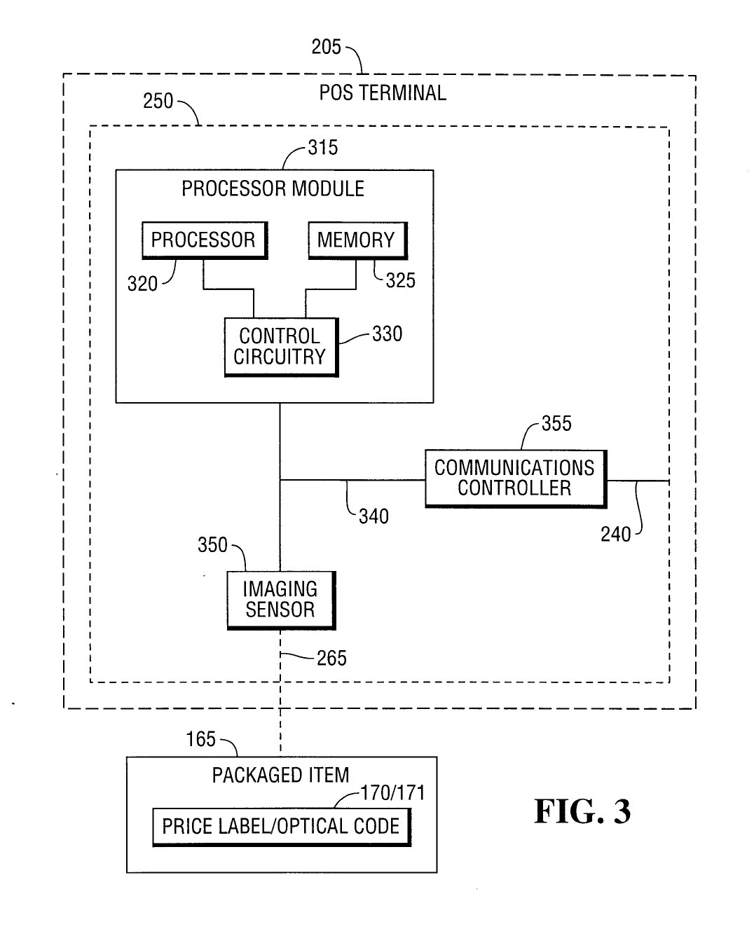

Referring now to FIG. 3, there is provided a high-level block diagram illustrating an exemplar embodiment of an imaging scanner 250. The imaging scanner 250 reads an optical code by capturing an image of the optical code and processing the image to recover information stored in the optical code. The imaging scanner 250 communicates with the POS terminal 205 over the computer bus 240 using a local communications controller 355. The imaging scanner 250 further includes a processor module 315 and an imaging sensor 350.

The processor module 315 includes a processor 320, a memory 325 and control circuitry 330. The memory 325 includes both volatile and non-volatile memory. Software stored in the memory 325 is executed by the processor 320 and causes the processor 320 to control the devices and operation of the imaging scanner 250 including the processing of captured images to identify an optical code and recover information stored in the optical code. When information is recovered from an optical code, the information is sent to the POS terminal 205 using the data bus 240. The processor 320 in the imaging scanner 250 processes the captured image but in some embodiments additional processing of the image or of the recovered information is performed by the processor 220 in the POS terminal 205.

The control circuitry 330 provides an interface between the processor 320 and the memory 325 and between the processor 320 a data bus 340 used to communicate with other devices that comprise the imaging scanner 250 including but limited to the imaging sensor 350 and the communications controller 355. In some embodiments, all or a portion of the memory 325 is connected directly to the processor 320.

The communications controller 355 includes hardware and software required to communicate with the POS terminal 205 over the data connection 260. In some embodiments, the data connection 240 is implemented using an industry standard USB bus.

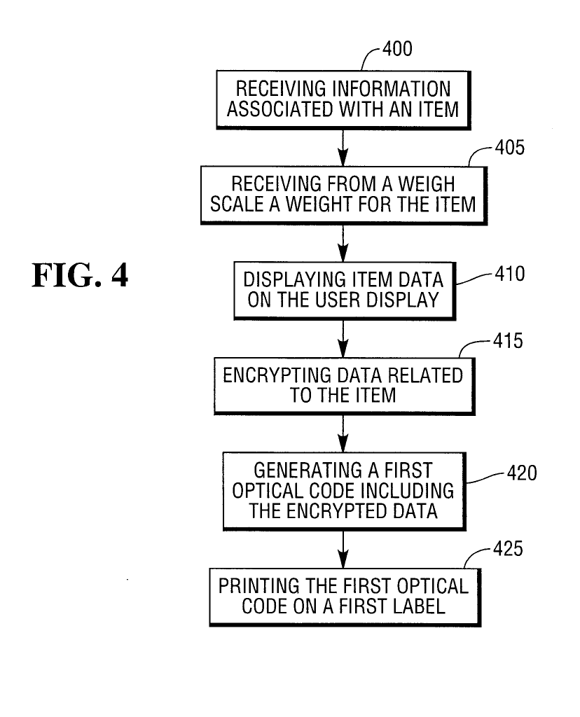

Turning to FIG. 4, there is provided a high-level flow chart illustrating an exemplar method for generating a label for a variable weight item including encrypted data. This method is implemented using the scaling and labeling device 105. In step 400, the processor 120 receives information associated with an item 165. The information can be entered on the user display/touch screen display 160 or it can be retrieved from the computer server 180 over the computer network 175 or a combination of both. The entered or retrieved information is associated with the item 165 and includes a description of the item, a price per unit weight and a private encryption key. The scaling and labeling device 105 uses a public/private cryptography system and the private encryption key to encrypt a portion of the information related to the item 165.

The cryptography system uses a public key and a matching private key. The private key is generally used to encrypt data and is kept secret while the public key is made public and is generally used to decrypt the data. Only matching keys will work to encrypt and decrypt data. In some embodiments the information associated with the item 165 includes party identification information associated with the encryption method. The party identification information identifies the company that operates the scaling and labeling device 105 and is used to retrieve a public key for the company that matches the private key used to encrypt the data.

In some embodiments, the cryptography system used by the scaling and labeling device 105 does not use the public-key cryptography system but instead uses a simpler cipher such as the XOR cipher discussed above.

In step 405, the item 165 is placed on the weigh scale 145 and the processor 120 receives a weight for the item 165 from the weigh scale 145. In step 410, the processor 120 displays data for the item 165 on the user display/touch screen 160. This information includes the weight of the item 165 and the total price calculated by multiplying the weight of the item 165 by the unit price for the item 165.

In step 415, the processor 120 encrypts data related to the item 165. The data related to the item 165 includes the weight of the item 165. In some embodiments, the data includes an expiration date that is used to determine when an item can not longer be sold. It also prevents the use of the optical code after the expiration date in a fraudulent manner. In still other embodiments, the data includes identification information about the item 165. The processor 120 encrypts the data related to the item 165 using the private encryption key and a public/private key cryptography system. In some embodiments, the cryptography system is based on RSA's public/private key cryptography system. In other embodiments, the cryptography system is based on simple cipher such as an XOR cipher.

In step 420, the processor 120 generates a first optical code that includes the encrypted data and non-encrypted data. In step 425, the processor 120 prints the first optical code 171 on a first label 170 using the label printer 150. The first label 170 is then applied to the item 165. In some embodiments, a second optical code is generated and printed on a second label. The second label is then applied to the item 165 generally in an area away from the first label making it difficult for a cell phone to take a photo of both at one time.

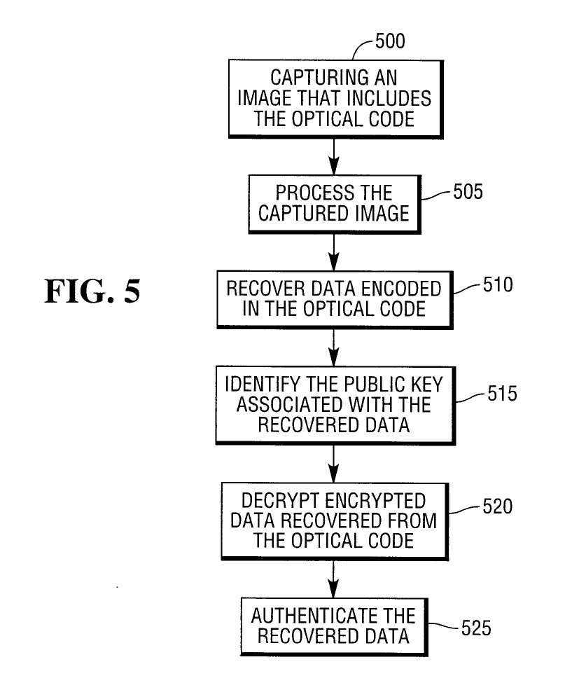

Turning to FIG. 5, there is provided a high-level flow chart illustrating an exemplar method for reading a label for a variable weight item including encrypted data. In this example, the optical code 171 generated by the scaling and labeling device 105 as illustrated in FIG. 4 is presented to the POS terminal 205 and read.

In step 500, the imaging scanner 250 captures an image that includes the optical code 171. The optical code 171 is printed on the price label 170 which is attached to packaged item 165. The packaged item 165 is being presented to the POS terminal 205 for scanning as part of a purchase transaction. In step 505, the captured image is processed by the processor 320 in the imaging scanner 250 to determine if an optical code is present. In step 510, the processor 320, after determining that an optical code was present, recovers the data stored in the optical code 171. Storing data in an optical code means translating the data from one form such as simple text to the form used by the optical code to store data. Any cryptographic functions would be in addition to the process of storing data into an optical code. Therefore, the data initially recovered from the optical code 171 includes both clear text (never encrypted text) and encrypted data.

In step 515, the processor 320 identifies the public key associated with the recovered data. In some embodiments, the recovered data includes a party identifier that identifies the party responsibly for creating the optical code and is used to identify a public key associated with the recovered data. In some embodiments, multiple different public keys are stored in a database on the computer server 210 and the processor 320 queries the database and retrieves the proper public key from the database. In step 520, the processor 320 decrypts the portion of the recovered data that is encrypted using the identified public key to create a plain text version. The recovered data now includes clear text information which is information that was never encrypted and plain text information which was decrypted from the encrypted information. In step 525, the processor 320 authenticates a portion of the recovered data. In some embodiments, authenticating includes performing a hashing function on a portion of the recovered data and comparing the resulting signature to a signature that was included as part of the encrypted data. If the two signatures are identical, it proves the data has not been altered and authenticates the data.

In some embodiments, the cryptographic system does not involve using a public-key cipher but instead uses a simpler cipher such as an XOR cipher as disclosed above. In these embodiments, authentication is involves using a generic checksum or a check digit concept as disclosed by GS1 in their General Specification.

In some embodiments, steps 515-525 are performed by the processor 220 in the POS terminal 205. The data recovered from the optical code 171 in step 510 is sent to the processor 220 in the POS terminal 205 which then performs steps 515-525. In these embodiments, the processor 220 in the POS terminal 205 is faster than the processor 320 in the imaging scanner 250 and can perform the cryptographic functions faster.

In still other embodiments, the packaged item 165 has a second optical code that contains additional security information that must be recovered before the encrypted information the first optical code 171 can be decrypted or authenticated.

Although particular reference has been made to an embodiment that includes a POS terminal and examples have been provided illustrating the invention in a POS system, certain other embodiments, variations and modifications are also envisioned within the spirit and scope of the following claims. For example, there are embodiments where the invention is used in systems that do not involve processing items for purchase.

I claim:

1) An optical code scanner including:
an image capture device where the image capture device captures an image of an optical code presented to the optical code scanner for reading;
a computer memory adapted to store computer data and computer executable instructions; and
a processor in communication with the image capture device, and the computer memory where the processor executes the instructions and where the instructions cause the processor to perform steps including:
receiving the captured image of the optical code from the image capture device;
processing the received image to recover data stored in the optical code where a portion of the recovered data is encrypted;
identifying a cryptographic key associated with the recovered data from optical code;
decrypting using the cryptographic key the encrypted portion of the recovered data to produce a clear text version of the encrypted portion; and
authenticating the recovered data using information from the clear text version of the encrypted data and rejecting the optical code if the authentication fails and accepting the optical code data if the authentication passes.

2) The optical code scanner of claim 1, wherein the authenticating step includes generating a current hashing signature using a portion of the recovered data from the optical code and comparing it to an original hashing signature stored in the encrypted portion of the recovered data.

3) The optical code scanner of claim 1, wherein decrypting the encrypted data includes using a public/private cryptography system where one key of a public/private key pair is used to decrypt the data.

4) The optical code scanner of claim 3, wherein the recovered data includes a party identifier and wherein identifying a cryptographic key includes using the party identifier to identify the cryptographic key associated with the recovered data.

5) A point of sale terminal comprising:
an optical code scanner adapted to read optical codes for items presented to the optical code scanner for reading;
a computer memory adapted to store computer data and computer executable instructions; and
a processor in communication with the computer memory and optical code scanner where the processor executes the instructions and where the instructions cause the processor to perform steps including:
receiving from the optical code scanner first data stored in a first optical code where a portion of the first data is encrypted;
identifying a cryptographic key associated with the received first data read;
decrypting using the cryptographic key the portion of the received first data that is encrypted; and
authenticating the decrypted first data and rejecting the optical code if the authentication fails and processing the optical code data if the authentication passes.

6) The point of sale terminal of claim 5, further including a weigh scale in communication with the processor, and wherein the encrypted data includes a stored weight for the item, and wherein processing the optical code if the authentication passes includes verifying that a weight determined by the weigh scale for the item matches the stored weight of the item included in the optical code.

7) The point of sale terminal of claim 5, wherein the authenticating step includes generating a hashing signature using data from the optical code and comparing it to a hashing signature stored in the encrypted data.

8) The point of sale terminal of claim 5, wherein decrypting the encrypted data includes using a public/private cryptography system where one key of a public/private key pair is used to decrypt the data.

9) The point of sale terminal of claim 8, wherein the recovered data includes a party identifier and wherein identifying a cryptographic key includes using the party identifier to identify the cryptographic key associated with the recovered data.

10) The point of sale terminal of claim 5, wherein the instructions further cause the processor to perform steps including:
receiving from the optical code scanner second data stored in a second optical code; and
wherein the step of authenticating the decrypted first data includes using the received second data.

11) A computer implemented method for reading an optical code where a portion of the data stored in the optical code is encrypted, the method comprising:
processing an image of the optical code to recover data stored in the optical code where a portion of the recovered data is encrypted;
identifying a cryptographic key associated with the recovered data from optical code;
decrypting using the cryptographic key the encrypted portion of the recovered data; and
authenticating the recovered data using a portion of the decrypted data and rejecting the optical code if the authentication fails and accepting the optical code data if the authentication passes.

12) The method of claim 11, wherein the authenticating step further includes generating a current hashing signature using a portion of the recovered data from the optical code and comparing it to an original hashing signature stored in the encrypted portion of the recovered data.

13) The method of claim 11, wherein decrypting the encrypted data includes using a public/private cryptography system where one key of a public/private key pair is used to decrypt the data.

14) The method of claim 12, wherein the recovered data includes a party identifier and wherein identifying a cryptographic key includes using the party identifier to identify the cryptographic key associated with the recovered data.

15) The method of claim 11, further comprising:
verifying that a current weight for an item associated with the optical code matches an item weight stored in the encrypted portion of the recovered data.

16) The method of claim 11, wherein the authenticating step includes generating a hashing signature using data from the optical code and comparing it to a hashing signature stored in the encrypted data.

17) The method of claim 11, further comprising:
receiving from the optical code scanner second data stored in a second optical code; and
wherein the step of authenticating the recovered data includes using the received second data.

18) An optical code scanner including:
A laser scanning device where the laser scanner device captures data from an optical code presented to the optical code scanner for reading;
a computer memory adapted to store computer data and computer executable instructions; and
a processor in communication with the laser scanning device, and the computer memory where the processor executes the instructions and where the instructions cause the processor to perform steps including:
receiving the captured date from the optical code from the laser scanning device;
processing the received data to recover data stored in the optical code where a portion of the recovered data is encrypted;
identifying a private cryptographic key associated with the recovered data from optical code;
decrypting using the private cryptographic key the encrypted portion of the recovered data to produce a clear text version of the encrypted portion; and
authenticating the recovered data using information from the clear text version of the encrypted data and rejecting the optical code if the authentication fails and accepting the optical code data if the authentication passes.

19) The optical code scanner of claim 18 wherein decrypting the encrypted portion includes using an XOR cipher and wherein the optical code is a one dimensional barcode and wherein authenticating the recovered data includes using a checksum.
